(19) United States
(12) Patent Application Publication
(10) Pub. No.: US 2015/0128164 A1
(43) Pub. Date: May 7, 2015

(54) SYSTEMS AND METHODS FOR EASILY DISABLING INTERACTIVITY OF INTERACTIVE IDENTIFIERS BY USER INPUT OF A GEOMETRIC SHAPE

(71) Applicant: United Video Properties, Inc., Santa Clara, CA (US)

(72) Inventors: Andrew Fundament, Arlington Heights, IL (US); David John Wheatley, Tower Lakes, IL (US); Vanessa Wickenkamp, Elmhurst, IL (US); Amanda Mallardo, Streamwood, IL (US)

(73) Assignee: UNITED VIDEO PROPERTIES, INC., Santa Clara, CA (US)

(21) Appl. No.: 14/074,322

(22) Filed: Nov. 7, 2013

Related U.S. Application Data
(60) Provisional application No. 61/900,868, filed on Nov. 6, 2013.

(51) Int. Cl. H04N 21/475; H04N 21/4627; H04N 21/482; H04N 21/454

(52) U.S. Cl. CPC H04N 21/4751; H04N 21/454; H04N 21/4627; H04N 21/482
USPC 725/25

(57) ABSTRACT

Methods and systems are provided herein for enabling users to seamlessly restrict access to media assets. These methods and systems are provided by way of generating for display a plurality of interactive identifiers on a scrollable page. A user input of a geometric shape is then received on the scrollable page, such that interactive identifiers are within the area of the geometric shape. It is then determined that a particular interactive identifier of the plurality of interactive identifiers is within the area of the geometric shape, and disabling the interactivity of the particular interactive identifier in response to this determination. Once the interactivity of the particular interactive identifier is disabled, the interactivity of the particular interactive identifier will remain disabled when its position on a display changes as the result of the scrollable page being scrolled.

### CROSS-REFERENCE TO RELATED APPLICATIONS

This application claims the benefit of U.S. Provisional Patent Application No. 61/900,868, now pending, filed Nov. 6, 2013, the contents of which is hereby incorporated herein by reference in its entirety.

### BACKGROUND

It is commonplace for users to set parental controls on media assets such that children are unable to access media assets that a parent does not deem fit. Many parental control interfaces are cumbersome to use and require individual selection of each single media asset a parent wishes to restrict. As technology has advanced, users have become impatient with such individual selection and desire an easier tool to restrict offensive media assets.

### SUMMARY

Methods and systems are provided herein for enabling users to seamlessly restrict access to media assets. These methods and systems are provided by way of generating for display a plurality of interactive identifiers on a scrollable page (e.g., an icon representing a single movie, or an icon representing a category of on-demand media content). A user input of a geometric shape (e.g., a circle) may then be received on the scrollable page, such that interactive identifiers are within the area of the geometric shape. The user input may be performed, for example, by highlighting a region using a mouse or pointer device, or may be performed using one's finger or a stylus to draw or expand a shape that encompasses one or more interactive identifiers. It may then be determined that a particular interactive identifier of the plurality of interactive identifiers is within the area of the geometric shape, and the interactivity of the particular interactive identifier may be disabled in response to this determination. Once the interactivity of the particular interactive identifier is disabled, the interactivity of the particular interactive identifier may remain disabled when the position of the particular interactive identifier on a display changes as the result of the scrollable page being scrolled.

In some embodiments, in addition to the particular interactive identifier being within the area of the geometric shape, another identifier may also be within the area of the geometric shape. For example, an interactive identifier for a “Mature” rated movie may be within an area of a geometric shape that also includes an interactive identifier for a movie rated for “Everyone.” In some embodiments, both the “Mature” and the “Everyone” movie may have the interactivity of their corresponding interactive identifiers disabled. In other embodiments, only one of the two movies may have the interactivity of its corresponding interactive identifiers disabled. For example, if a parent is setting content restrictions to ensure only content suitable for a child is accessible, then the system may disable only the interactivity of the interactive identifier associated with the “Mature” rated movie and may maintain the interactivity of the interactive identifier associated with the “Everyone” rated movie. The system may alternatively or additionally render the disabled interactive identifier invisible, and may also render anything associated with the disabled interactive identifier invisible as well (e.g., box art, etc.).

In some embodiments, a selection of an interactive identifier of the plurality of interactive identifiers may be received on a first user equipment device, and a media asset corresponding to the selected interactive identifier may be generated for display on a second user equipment device. For example, the selection may be made on a tablet computer (e.g., an iPad), and the display may be made on a larger display (e.g., television).

In some embodiments, the user input of the geometric shape is performed at a first device (e.g., a tablet computer like an iPad), and media associated with the particular interactive identifier is restricted at a second device (e.g., a television) in response to determining that the second interactive identifier is within the area of the geometric shape. In some embodiments, the particular interactive identifier may be an identifier within the area of a geometric shape drawn on a first user equipment device (e.g., a tablet computer), where the particular interactive identifier is associated with on-demand media content, and consequentially all on-demand media content is restricted at a second user equipment device (e.g., a television device). In some embodiments, the content that is restricted at the second device may be visually distinguished from the content that is not restricted at the second device. For example, the content that is restricted at the second device may be displayed in gray, whereas the content that is not restricted at the second device may be displayed in a brighter color like white. As another example, the content that is restricted at the second device may be rendered invisible. Additionally, anything associated with the content that is restricted at the second device may be rendered invisible as well (e.g., box art, etc.).

In some embodiments, a profile of a current user is determined, and the preferences of the current user may be determined therefrom. For example, a profile of an adult user might show that the user enjoys media assets associated with violence. Accordingly, a set of interactive identifiers of the plurality of interactive identifiers that are within the area of the geometric shape may be determined that are unlikely to be preferred by the current user based on the preferences of the user, and the interactivity of the set of interactive identifiers may be disabled. For example, the aforementioned user may draw a shape around interactive identifiers that represent children's shows, soap operas, and action movies, and the interactive identifiers corresponding to the children's shows and soap operas may responsively have their interactivity disabled because children's shows and soap operas are not associated with violence.

In some embodiments, an amount of the particular interactive identifier that is within the area of the geometric shape may be determined and compared to a threshold, where when the amount exceeds the threshold, the particular interactive identifier is disabled. For example, if the shape only covers forty percent of an interactive identifier, and the threshold is half of an interactive identifier, it may be determined that the interactivity of the interactive identifier will not be disabled. This feature may be implemented to prevent the unintentional disablement of the interactivity of interactive identifiers.

In some embodiments, a request to enter a password may be received. This request may cause a prompt comprising a password input field, where, when a correct password is received, the interactivity of all disabled interactive identifiers is restored. For example, if a parent disables a media asset intended for mature audiences such that a child cannot watch it, and then desires to watch it himself, the parent may enter a password and proceed to view the media asset.

In some embodiments, a user input that defines a threshold rating may be received. From a global set of interactive identifiers within the area of the geometric shape, two sets of interactive identifiers may be determined - the first set including interactive identifiers that are associated with a rating that meets or exceeds the threshold rating, and the second set including interactive identifiers that are not associated with a rating that meets or exceeds the threshold rating. Following the determination, the interactivity of the first set of interactive identifiers may be disabled, and the interactivity of the second set of interactive identifiers may be maintained. For example, a user may have a child that is 12 years old, and, therefore, may set a threshold for media assets that the child may not view at TV-14. Accordingly, of the interactive identifiers within the geometric shape drawn by the user, any interactive identifier associated with media assets with a rating of TV-14 or higher may be restricted.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information, in accordance with some embodiments of the disclosure;

FIG. 2 shows another illustrative embodiment of a display screen that may be used to provide media guidance application listings, in accordance with some embodiments of the disclosure;

FIG. 3 is a block diagram of an illustrative user equipment (UE) device in accordance with some embodiments of the disclosure;

FIG. 4 is a block diagram of an illustrative media system in accordance with some embodiments of the disclosure;

FIG. 5 shows an illustrative embodiment of a user equipment device that may display a plurality of selectable interactive identifiers which are subject to having their interactivity disabled in response to user input, in accordance with some embodiments of the disclosure;

FIG. 6A shows an illustrative embodiment of a user equipment device that may display a plurality of selectable interactive identifiers that may have their interactivity disabled in response to user input, in accordance with some embodiments of the disclosure;

FIG. 6B shows an illustrative embodiment of a user equipment device that may display a plurality of selectable interactive identifiers that may have their interactivity disabled in response to user input and user-set criteria, in accordance with some embodiments of the disclosure;

FIG. 6C shows an illustrative embodiment of a user equipment device that may display a plurality of selectable interactive identifiers that may have their interactivity disabled, where the interactivity of the interactive identifiers whose interactivity is disabled remains disabled when a scrollable page is scrolled, in accordance with some embodiments of the disclosure;

FIG. 7 shows an illustrative embodiment of a user equipment device that may display selectable threshold ratings, in accordance with some embodiments of the disclosure;

FIG. 8A shows an illustrative embodiment of a user equipment device that may display a plurality of selectable interactive identifiers reflecting categories, in accordance with some embodiments of the disclosure;

FIG. 8B shows an illustrative embodiment of a user equipment device that may display a plurality of selectable interactive identifiers reflecting categories, where one interactive identifier has its interactivity disabled, in accordance with some embodiments of the disclosure;

FIG. 8C shows an illustrative embodiment of a user equipment device that may display a plurality of selectable interactive identifiers reflecting categories, where one interactive identifier of the plurality of selectable identifiers has its interactivity disabled in response to user input received at a different user equipment device, in accordance with some embodiments of the disclosure;

FIG. 9A shows an illustrative embodiment of a user equipment device that may display a plurality of selectable interactive identifiers and may receive user input of a geometric shape, in accordance with some embodiments of the disclosure;

FIG. 9B shows an illustrative embodiment of a user equipment device that may display a plurality of selectable interactive identifiers, where the interactivity of some interactive identifiers of the plurality of interactive identifiers is disabled if a threshold amount of an interactive identifier is within the area of the geometric shape, in accordance with some embodiments of the disclosure;

FIG. 10 shows an illustrative embodiment of a user equipment device that may display a prompt for a user to enter a password, in accordance with some embodiments of the disclosure;

FIG. 11A is a flowchart of illustrative steps involved in disabling the interactivity of interactive identifiers on a scrollable page that are within the area of a user input geometric shape, in accordance with some embodiments of the disclosure;

FIG. 11B is a flowchart of illustrative steps involved in determining whether a particular interactive identifier on a scrollable page is within the area of the geometric shape based on the coordinates of the geometric shape and the coordinates of the particular interactive identifier, in accordance with some embodiments of the disclosure;

FIG. 12 is a flowchart of illustrative steps taken to disable the interactivity of a particular interactive identifier at a second user equipment device based on the received user input of a geometric shape at a first user equipment device, in accordance with some embodiments of the disclosure;

FIG. 13 is a flowchart of illustrative steps involved in a determination of whether to disable a particular interactive identifier that is within the area of a user input geometric shape, in accordance with some embodiments of the disclosure;

FIG. 14 is a flowchart of illustrative steps involved in enabling the interactivity of disabled interactive identifiers in response to the correct entry of a password by a user, in accordance with some embodiments of the disclosure;

FIG. 15A is a flowchart of illustrative steps taken to selectively disable the interactivity of a first set of interactive identifiers within the area of a user input geometric shape and maintain the interactivity of a second set of interactive identifiers within the area of the user input geometric shape, in accordance with some embodiments of the disclosure;

FIG. 15B is a flowchart of illustrative steps taken to distinguish interactive identifiers of a global set of interactive identifiers within the area of a geometric shape that meet or exceed a threshold rating from those that do not meet or exceed the threshold rating, in accordance with some embodiments of the disclosure; and

FIG. 16 is a flowchart of illustrative steps taken to selectively disable the interactivity of a set of interactive identifiers within the area of a user input geometric shape which are unlikely to be preferred by a user who input the geometric shape, in accordance with some embodiments of the disclosure.

### DETAILED DESCRIPTION OF EMBODIMENTS

Methods and systems are provided herein for enabling users to seamlessly restrict access to media assets. These methods and systems are provided by way of generating for display a plurality of interactive identifiers on a scrollable page (e.g., an icon representing a single movie, or an icon representing a category of on-demand media content). A user input of a geometric shape (e.g., a circle) may then be received on the scrollable page, such that interactive identifiers are within the area of the geometric shape. The user input may be performed, for example, by highlighting a region using a mouse or pointer device, or may be performed using one's finger or a stylus to draw or expand a shape that encompasses one or more interactive identifiers. It may then be determined that a particular interactive identifier of the plurality of interactive identifiers is within the area of the geometric shape, and the interactivity of the particular interactive identifier may be disabled in response to this determination. Once the interactivity of the particular interactive identifier is disabled, the interactivity of the particular interactive identifier may remain disabled when the position of the particular interactive identifier on a display changes as the result of the scrollable page being scrolled.

The term “interactive identifier” wherever used in this disclosure refers to any object that reacts in response to user input and acts to identify media of any kind. This may be an icon, a link, a media listing (e.g., program listing), or any other selectable object that leads to any consequence when selected.

The term “geometric shape” wherever used in this disclosure refers to the product of any form of user input that acts to select, cover, highlight, or cursor one or more interactive identifiers. The user input may be received by control circuitry via interaction between a user equipment device and a peripheral device (e.g., a mouse), a stylus or other instrument of communication between a human and a user equipment device, or a body part such as a hand or finger. The geometric shape may be any regular shape (e.g., square, rectangle, triangle, circle) or any irregular shape. The geometric shape may be a closed shape (i.e., has an unbroken perimeter) or may be an open shape. If the geometric shape is an open shape, control circuitry may approximate a closed shape by interpolating the remainder of the shape's perimeter.

The term “scrollable page” wherever used in this disclosure refers to a page that is only partially displayed, and may be navigated via user input such that in response to user input, a different portion of the page is displayed. The page may be navigated or “scrolled” in response to input via a peripheral device (e.g., a mouse), a stylus or other instrument of communication between a human and a user equipment device, or a body part such as a hand or finger.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

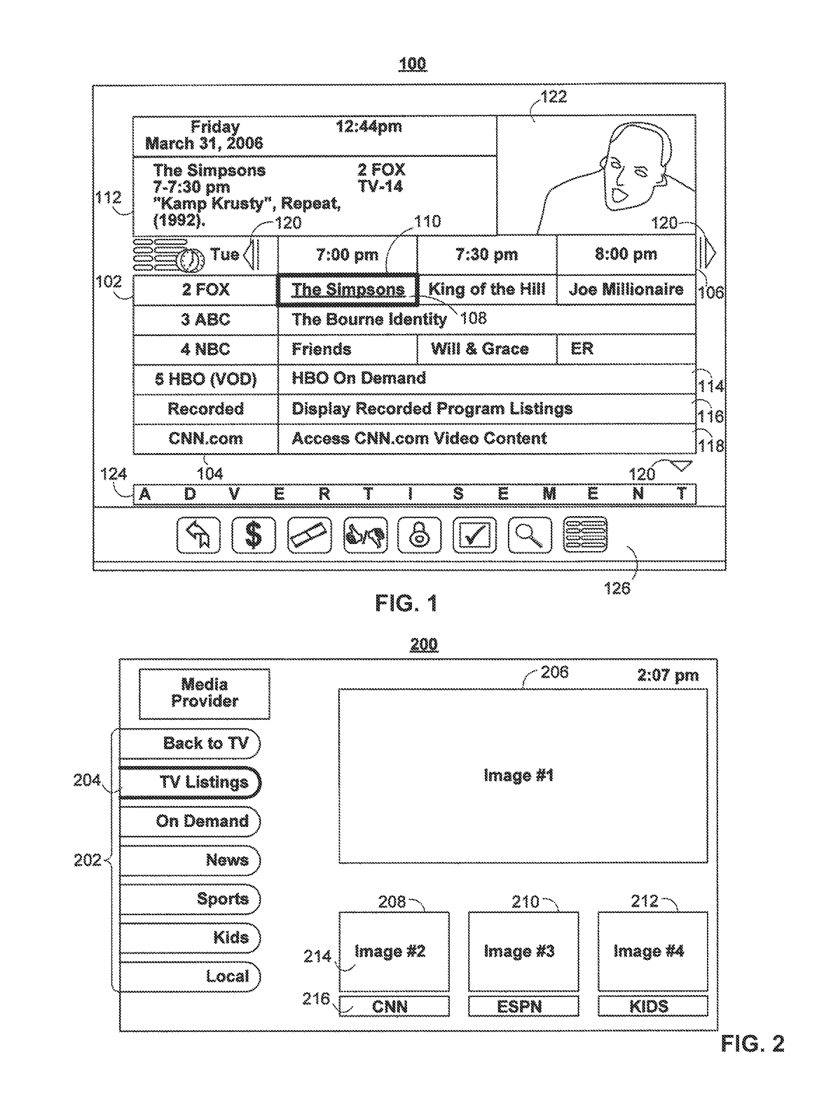

FIGS. 1-2 and 5-9 show illustrative display screens that may be used to provide media guidance data. The display screens shown in FIGS. 1-2 and 5-9 may be implemented on any suitable user equipment device or platform. While the displays of FIGS. 1-2 and 5-9 may be illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

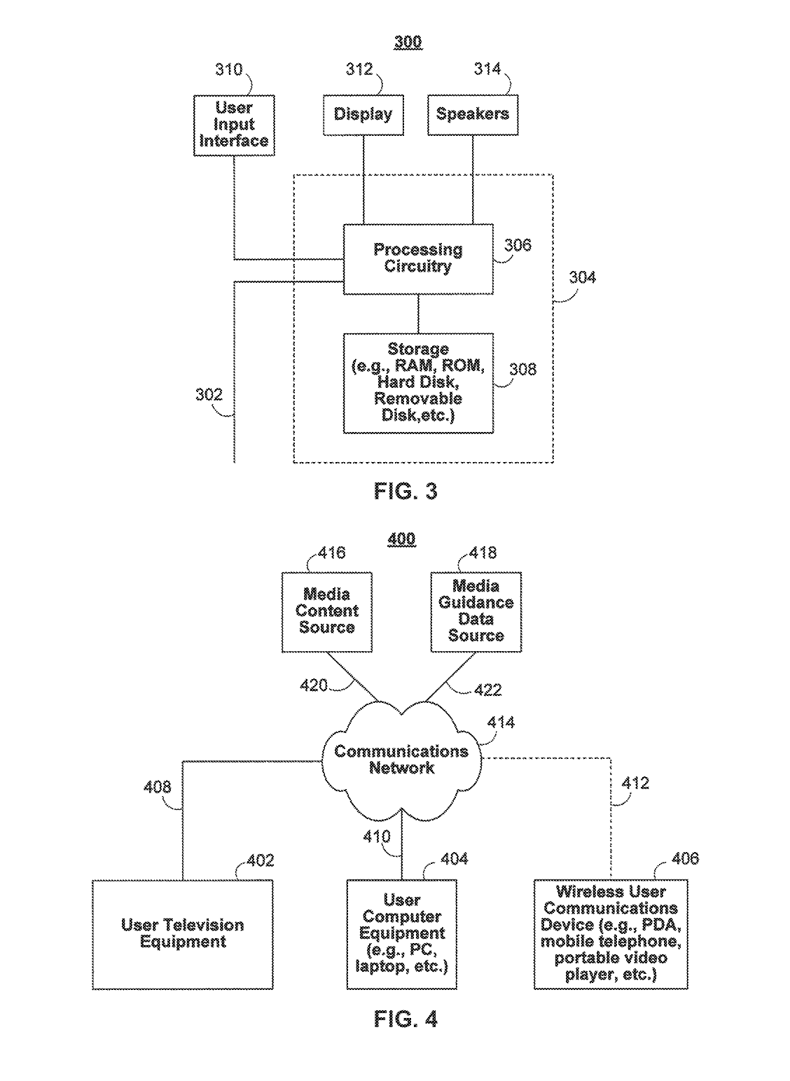

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, a user utilizing a user equipment device may wish to restrict access to media content, such as certain television shows. Control circuitry (e.g., control circuitry 304) may receive input of a geometric shape that covers within its area one or more interactive identifiers, such as television program shows, that correspond to the media content that the user wishes to restrict access to. The control circuitry may determine which interactive identifiers are within the area of the geometric shape, and disable the interactivity of those interactive identifiers. The disabled interactivity of the interactive identifiers may be maintained when control circuitry 304 causes a scrollable page on which the interactive identifiers are displayed to be scrolled (e.g., in response to user input to scroll the page).

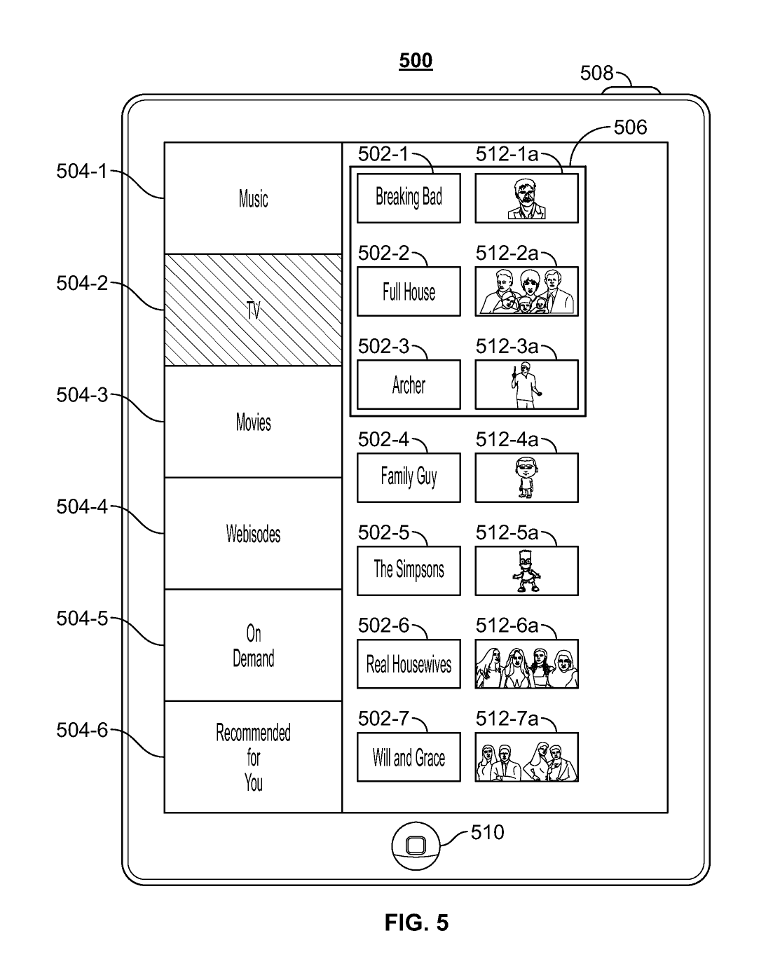

FIG. 5 shows an illustrative embodiment of a user equipment device that may display a plurality of selectable interactive identifiers which are subject to having their interactivity disabled in response to user input, in accordance with some embodiments of the disclosure. User equipment 500 may include control circuitry 304 that generates a display of various interactive identifiers, including media asset identifiers 502 and media content identifiers 504. Box art 510 may be displayed, and may be associated with an interactive identifier. User equipment 500 may comprise user television equipment 402, user computer equipment 404, or wireless user communications device 406. All interactive identifiers may be stored remotely and retrieved from media guidance data source 418 via communications network 414 by control circuitry 304. Alternatively, all interactive identifiers may be stored locally and may be retrieved locally from storage 308, the retrieval being performed by control circuitry 304. Media asset identifiers 502 may correspond to a category of content as selected by a user. For example, if control circuitry 304 receives a user selection of media content identifier 504-2, then television-related media asset identifiers 502 may be generated for display by control circuitry 304. Control circuitry 304 may receive a user selection of a media content identifier 504 via user input interface 310, where user input interface 310 may be a peripheral device such as a mouse or remote controller, an interactive instrument such as a stylus, or an interface that interacts with a body part such as a finger.

In some embodiments, a user may wish to view a media asset corresponding with a media asset identifier 502. To do so, control circuitry 304 may receive a user selection of a media asset identifier 502 via user input interface 310, which may be a peripheral device such as a mouse or remote controller, an interactive instrument such as a stylus, or an interface that interacts with a body part such as a finger. In response, control circuitry 304 may cause the media asset to be presented to the user. The media asset may be locally stored on user equipment device 500 or may be remotely stored at either a second user equipment device such as user television equipment 402. The media asset may alternatively be remotely stored at a database such as media content source 416, and may be accessed via communications network 414 by control circuitry 304. Control circuitry 304 may cause the media asset to be displayed at user equipment device 500, or at a different user equipment device. The different user equipment device may be a local user equipment device such as user television equipment 402, or a remote user equipment device, where the remote user equipment device receives the instruction to display the media asset via communications network 414 from control circuitry 304.

A user may wish to restrict access to an interactive identifier, such as a media content identifier 504 or a media asset identifier 502. In order to restrict access to an interactive identifier, control circuitry 304 may receive a user input of a geometric shape over the interactive identifier, and if the interactive identifier is within the area of geometric shape 506, the interactivity of the interactive identifier may be disabled. Control circuitry 304 may receive the user input of the geometric shape by determining a set of contact points of a stylus or a finger. Control circuitry 304 may determine whether geometric shape 506 includes an interactive identifier within its area by comparing the coordinates of the contact points against the coordinates of the interactive identifier, where, when the coordinates of the interactive identifier are within the area of the contact points, a positive determination may be made. As will be discussed below, decision points may be instituted to ensure that the interactivity of some interactive identifiers will not be disabled by control circuitry 304 despite being within the area of geometric shape 506. As will also be discussed below, decision points may be instituted to ensure that the interactivity of an interactive identifier is not disabled by control circuitry 304 if control circuitry 304 determines that a threshold amount of the interactive identifier is not within the area of geometric shape 506.

In some embodiments, control circuitry 304 may receive and process a user input of geometric shape 506 at any time a user attempts to input a geometric shape on the screen. In other embodiments, a user may need certain administrative rights to enter geometric shape 506, and control circuitry will deny user input of geometric shape 506 unless the administrative rights are proven. In some embodiments, to prove administrative rights, control circuitry 304 may require a user to enter a Restricted Access mode in order to enter geometric shape 506. Entry into the Restricted Access mode may require the receipt of a password by control circuitry 304. In some embodiments, the ability for a user to enter the Restricted Access mode may be triggered by the use of a button, such as button 508 or 510, where control circuitry 304 enables a user to enter the Restricted Access mode upon detection of the depression of the button. In some embodiments, the ability to enter Restricted Access mode may be triggered by control circuitry 304 receiving a selection of an interactive identifier associated with the Restricted Access mode via a menu.

In some embodiments, control circuitry 304 may disable the interactivity of all interactive identifiers within the area of a user input geometric shape.

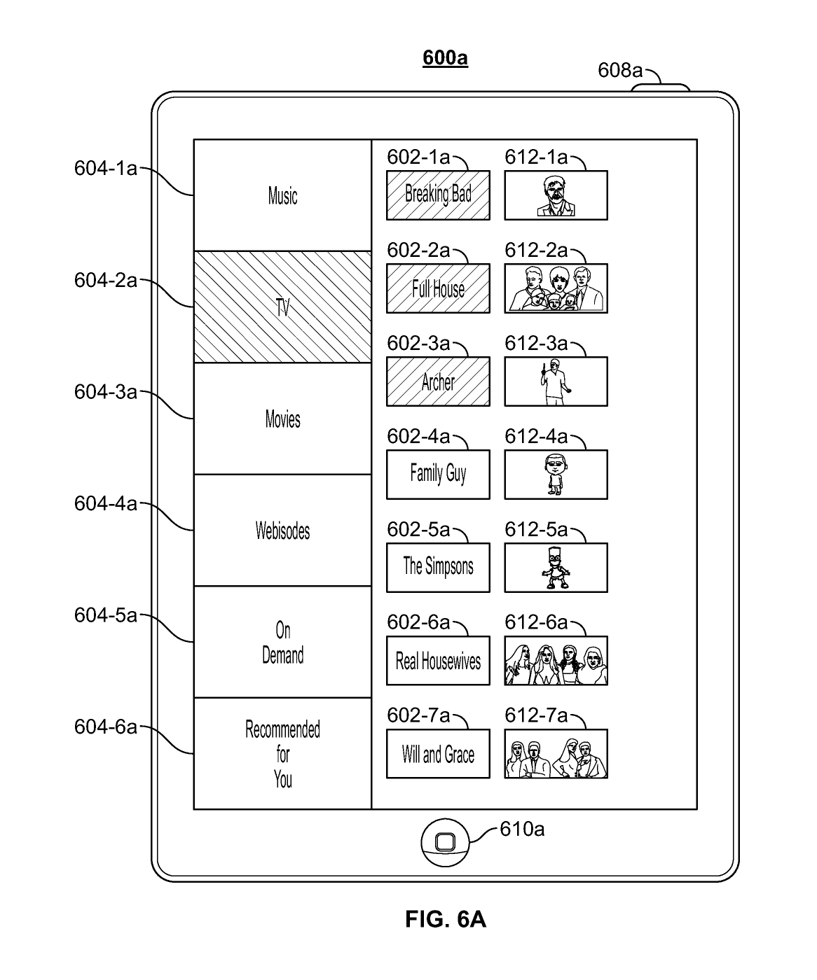

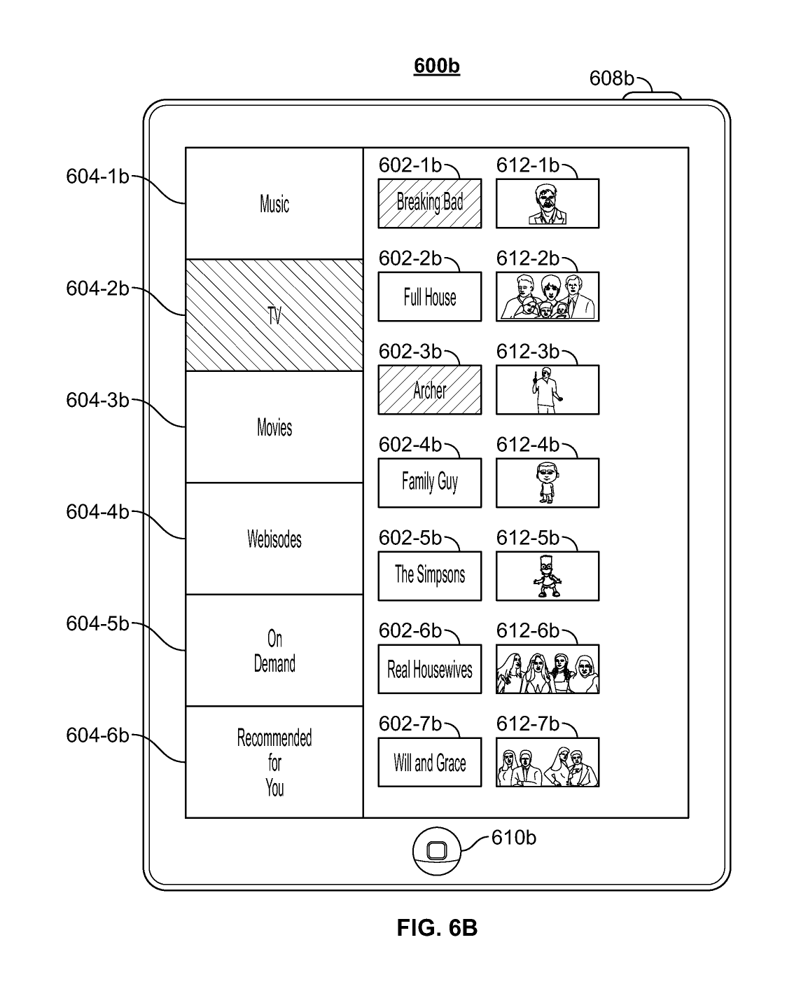

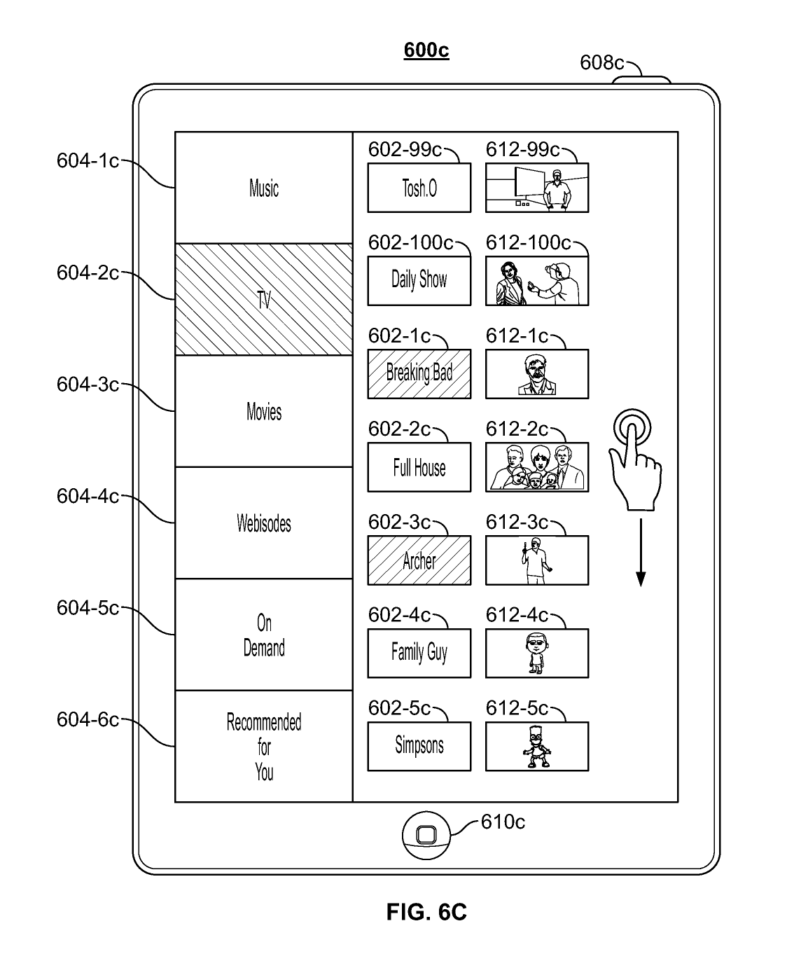

FIG. 6A shows an illustrative embodiment of a user equipment device that may display a plurality of selectable interactive identifiers that may have their interactivity disabled in response to user input, in accordance with some embodiments of the disclosure. Following from FIG. 5, where media asset identifiers 502-1, 502-2, and 502-3 are within the area of geometric shape 506, control circuitry 304 may cause the interactivity of corresponding media asset identifiers 602-1a, 602-2a, and 602-3a to be disabled. In some embodiments, control circuitry 304 may determine that the area of geometric shape 506 encompasses media asset identifiers 502-1, 502-2, and 502-3, and may cause the interactivity of media asset identifiers 502-1, 502-2, and 502-3 to be disabled. As described above, this determination may be made by control circuitry 304 comparing the coordinates of the interactive identifier to the coordinates of contact points of user input. In some embodiments, control circuitry 304 may cause media asset identifiers 602-1a, 602-2a, and 602-3a with disabled interactivity to be visually distinguished from enabled interactive identifiers 604 and 602-4a, 602-5a, 602-6a, and 602-7a by applying to media asset identifiers 602-1a, 602-2a, and 602-3a a difference in coloring, shading, brightness, greyscale, or any other feature that enables one to discern that the interactivity of media asset identifiers 602-1a, 602-2a, and 602-3a is disabled. In some embodiments, disabled media asset identifiers 602-1a, 602-2a, and 602-3a may be rendered invisible. In some embodiments, objects associated with the disabled interactive identifier may be rendered invisible such as box art 612-1a, 612-2a, and 612-3a.

In some embodiments, when control circuitry 304 receives a user input of a geometric shape, control circuitry 304 determines that a plurality of interactive identifiers are within the area of the geometric shape, but selectively disables the interactivity of only some of the plurality of interactive identifiers that are within the area of the geometric shape. Various criteria may be used by control circuitry 304 to determine whether the interactivity of an interactive identifier that is within the area of the geometric shape should be maintained, such as a rating of a media asset associated with the interactive identifier, or such as settings associated with a user profile.

FIG. 6B shows an illustrative embodiment of a user equipment device that may display a plurality of selectable interactive identifiers that may have their interactivity disabled in response to user input and user-set criteria, in accordance with some embodiments of the disclosure. Following from FIG. 5, control circuitry 304 has determined that media asset identifiers 602-1b, 602-2b, and 602-3b are within the area of geometric shape 506. Nevertheless, while the interactivity of media asset identifiers 602-1b and 602-3b is disabled, control circuitry 304 has not disabled the interactivity of media asset identifier 602-2b.

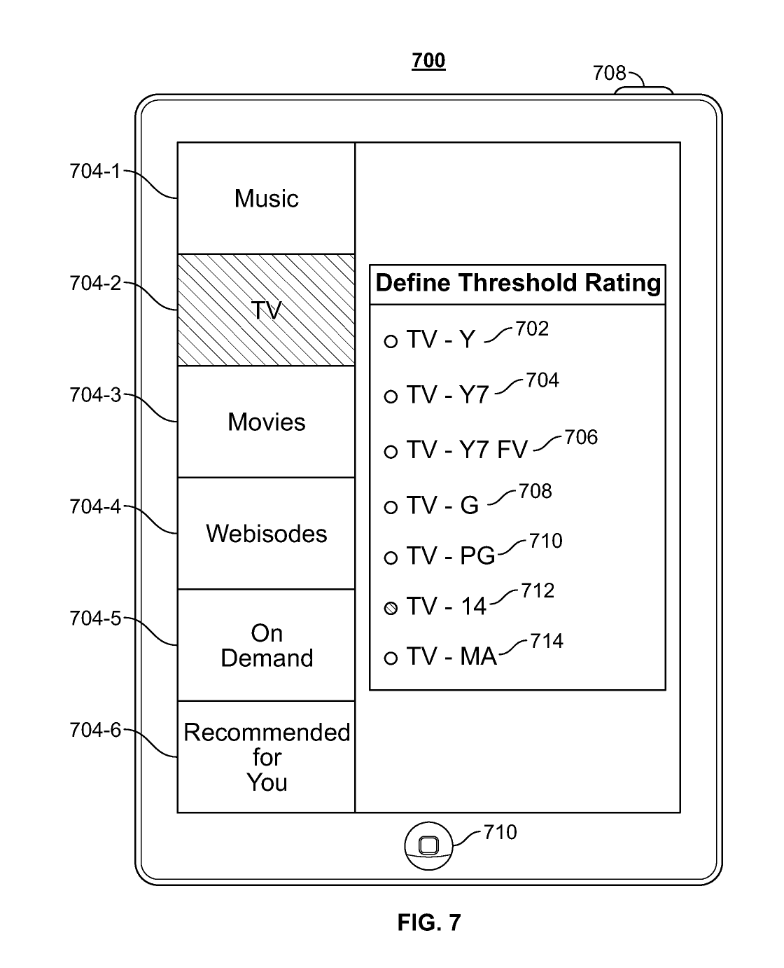

In some embodiments, control circuitry 304 makes the decision to maintain the interactivity of media asset identifier 602-2b based on a rating of a media asset associated with media asset identifier 602-2b. For example, control circuitry 304 may have received a user selection of a threshold rating of TV-14. This selection may have been received by control circuitry 304 receiving a user selection of rating 712 of FIG. 7. Each media asset associated with a media asset identifier 602b may also be associated with a rating 702, 704, 706, 708, 710, 712, or 714. Ratings may be associated with media asset identifiers in a database, such as media guidance data source 418. Control circuitry 304 may learn what rating a media asset is associated with by sending a query (e.g., an SQL query) to a database, such as guidance data source 418, and receive a response (e.g., an SQL response) in response to the query. Control circuitry 304 may then compare the rating to a threshold rating and determine whether it meets or exceeds the threshold rating.

Media assets associated with media asset identifiers 602-1b and 602-3b are associated with a rating of TV-MA, which exceeds the set threshold rating of TV-14. Accordingly, control circuitry 304 may disable the interactivity of media asset identifiers 602-1b and 602-3b in response to learning that the threshold rating is exceeded when performing a comparison. Media asset identifier 602-2b, however, is associated with a rating of TV-G, and therefore would not be determined to meet or exceed the set threshold rating of TV-14 by control circuitry 304 when a comparison is made. Accordingly, even though media asset identifier 602-2b is within the area of the user input geometric shape, control circuitry 304 may maintain the interactivity of media asset identifier 602-2b. The specifics of threshold ratings will be described below with regard to FIG. 7.

In some embodiments, control circuitry 304 may generate for display interactive identifiers at specific positions on a scrollable page. As described in the foregoing, control circuitry 304 may cause the interactivity of interactive identifiers to be disabled. When control circuitry 304 receives user input to scroll the scrollable page, the positions of displayed interactive identifiers on the display may shift. Control circuitry 304 may act to maintain the disability of a disabled interactive identifier when the page the disabled interactive identifier sits on is scrolled, despite a change in the disabled interactive identifier's position on the page.

FIG. 6C shows an illustrative embodiment of a user equipment device that may display a plurality of selectable interactive identifiers that may have their interactivity disabled, where the interactivity of the interactive identifiers whose interactivity is disabled remains disabled when a scrollable page is scrolled, in accordance with some embodiments of the disclosure.

In some embodiments, control circuitry 304 may detect user input (e.g., user input 610c) that directs a scrollable page that an interactive identifier is on to be scrolled. User input 610c may be detected by control circuitry 304, when input via user input interface 310, by a body part such as a finger, or may be input via a stylus, or may be input via a peripheral device such as a mouse, a trackball, or a scroll wheel. When control circuitry 304 causes the scrollable page to be scrolled responsive to user input 610c, control circuitry 304 may cause the positions of media asset identifiers 602 to shift. Although not depicted, control circuitry 304 may cause the positions of media content identifiers 604 to responsively shift as well. When control circuitry 304 causes the scrollable page to be scrolled responsive to user input 610c, the interactivity of media asset identifiers 602-1c and 602-3c, the interactivity of which was disabled during the activity associated with FIG. 6B, may be maintained by control circuitry 304.

FIG. 7 shows an illustrative embodiment of a user equipment device that may display selectable threshold ratings, in accordance with some embodiments of the disclosure. While ratings that correspond to The TV Parental Guidelines (see www.TVGuidelines.org) are depicted, this is for illustrative purposes only, and any ratings system may be utilized. Potential ratings systems that may be used consistent with this disclosure include MPAA movie ratings (i.e., “G,” “PG,” “PG-13,” etc.) and other ratings that correspond to a level of profanity or violence in a media asset. Alternatively, or additionally, ratings may indicate a popularity level or the opinion of a critic. For example, the average star-level on a five-star system may be used to define a threshold rating, where if a media asset associated with a media asset identifier has not achieved a certain star level, it may be disabled if within the area of a geometric shape.

Control circuitry 304 may cause user equipment device 700 to display a menu that allows a user to define a threshold rating. When a threshold rating is assigned, if an interactive identifier is within the area of geometric shape 506, control circuitry 304 may determine whether a media asset associated with the interactive identifier meets or exceeds the threshold rating. Control circuitry 304 may access a database (e.g., media guidance data source 416) to determine a rating associated with the media asset and/or the threshold rating. The database may be accessed via control circuitry sending media guidance data source 416 an SQL query via communications network 414, and receiving a SQL response via communications network 414. Control circuitry may compare the ratings based on a hierarchy of ratings, such as those depicted in FIG. 7, where a rating exceeds a threshold rating if it is further down the list than the threshold rating. In some embodiments, such as a parent wanting to restrict his children's access to inappropriate content, control circuitry 304 may disable the interactivity of a media asset identifier associated with the media asset that meets or exceeds the threshold rating that the parent set. In some embodiments, such as a user wishing only to browse highly acclaimed media assets, control circuitry 304 may disable the interactivity of interactive identifiers associated with media assets that do not meet or exceed the threshold rating.

In some embodiments, control circuitry 304 may detect a user may input of a geometric shape that, within its area, includes a media content identifier 504. For example, if control circuitry receives a user selection of threshold rating 712 (i.e., TV-14), and then receives a user input of geometric shape 506 around media content identifier 504-5 (i.e., “ON DEMAND”), control circuitry 304 may disable the interactivity of all interactive identifiers associated with on-demand content that meets or exceeds the rating of TV-14.

In some embodiments, control circuitry 304 may store the threshold rating in response to assignment by a user at a local user equipment device such as user television equipment 402. In some embodiments, control circuitry 304 may store the threshold rating when a remote request is received via communications network 414 from a remote user equipment device 700. In this manner, a parent may restrict content from afar, such as from a computer at a work place, such that a child cannot view inappropriate content from the child's television set or tablet computer.

In some embodiments, media content identifiers may be displayed on a user equipment device and reflect a category of media assets or of media asset identifiers. When selected, media asset identifiers may be viewed that correspond to the category. In some embodiments, a user may wish to disable an entire category, and may therefore draw a geometric shape around a media content identifier.

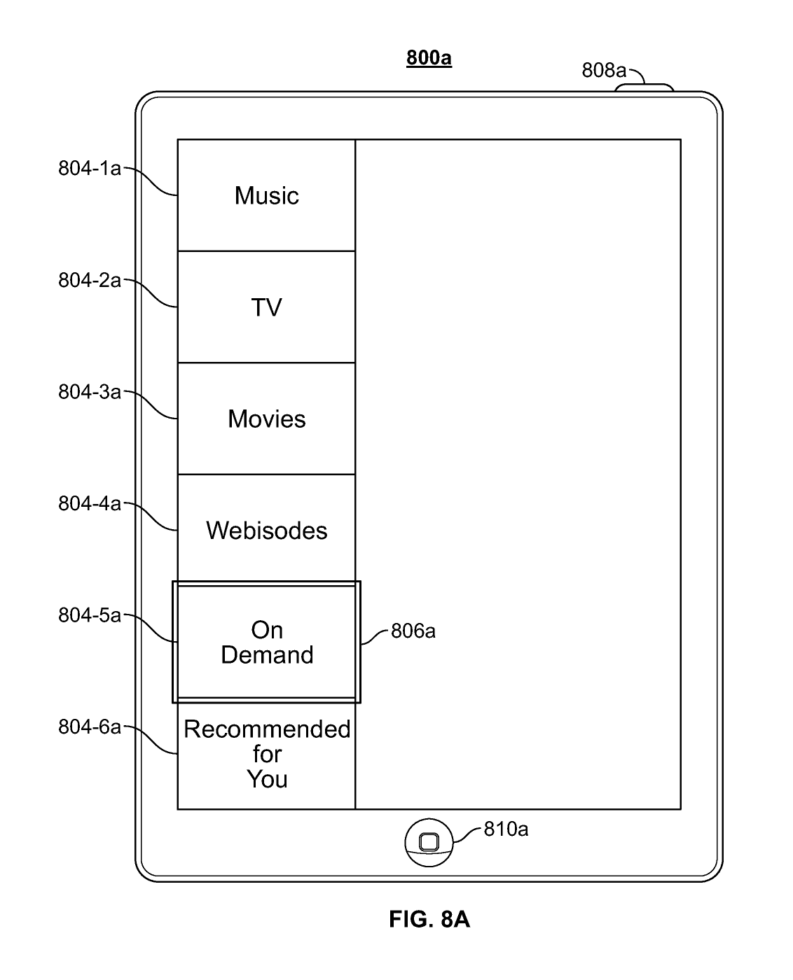

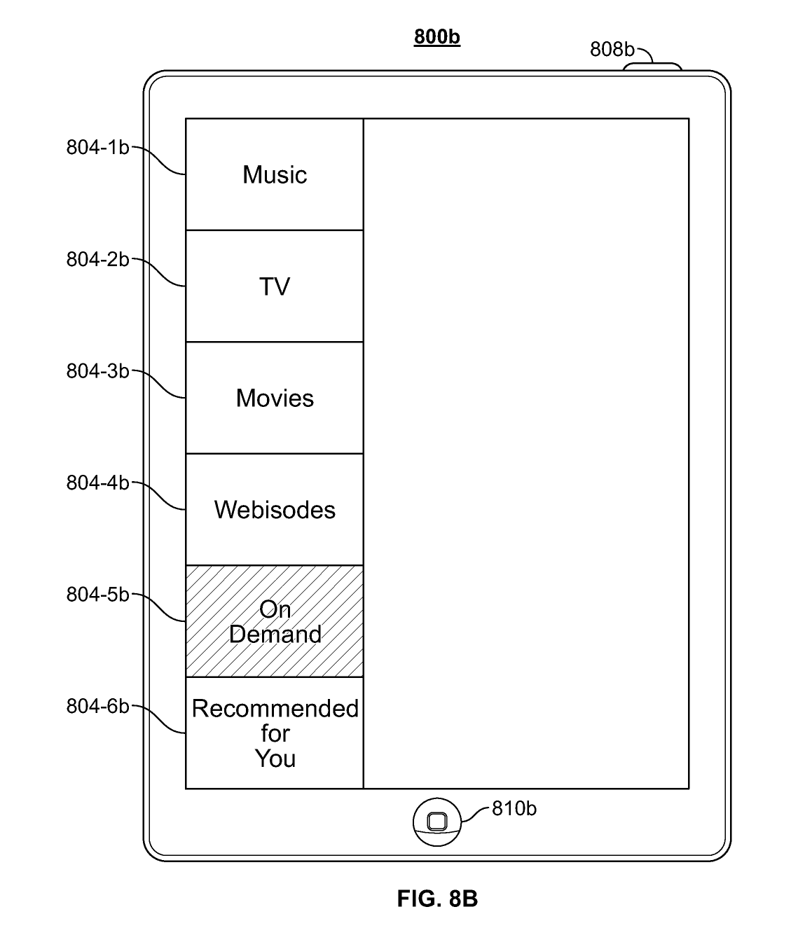

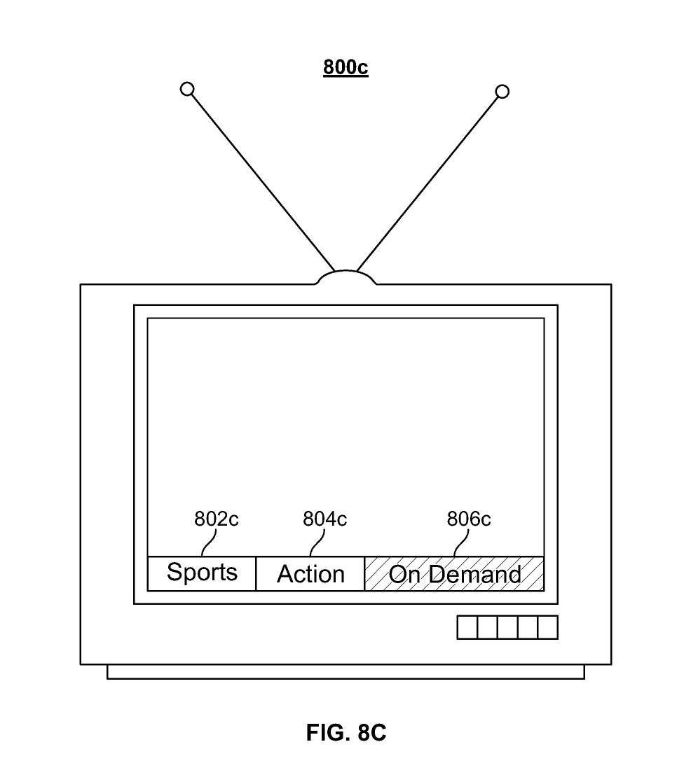

FIG. 8A shows an illustrative embodiment of a user equipment device that may display a plurality of selectable interactive identifiers reflecting categories, in accordance with some embodiments of the disclosure. User equipment 800a may display via display 312 media content identifiers 804a, as well as media asset identifiers 502 (not pictured in FIG. 8A for clarity), or any other interactive identifier. User equipment 800a may also include buttons 808a and 810a.

A user may input geometric shape 806a around interactive identifier 804-5a (i.e., a media content identifier reflecting On-Demand content). In response, control circuitry 304 may disable the interactivity of corresponding interactive identifiers as discussed in the foregoing.

FIG. 8B shows an illustrative embodiment of a user equipment device that may display a plurality of selectable interactive identifiers reflecting categories, where one interactive identifier has its interactivity disabled, in accordance with some embodiments of the disclosure. As discussed in the foregoing, control circuitry 304 may receive user input of geometric shape 806a via user input interface 310. When the geometric shape is received, control circuitry 304 may determine that interactive identifier 804-5a is within the area of geometric shape 806a (e.g., by comparing the coordinates of interactive identifier 804-5a to that of the coordinates of the contact points of the user input (described above with regard to FIG. 5 and FIG. 6)). Accordingly, control circuitry 304 may cause the interactivity of interactive identifier 804-5b to be disabled. When the interactivity of interactive identifier 804-5b is disabled, control circuitry 304 may cause interactive identifier 804-5b to be visually distinguished from other interactive identifiers that have maintained their interactivity.

When control circuitry 304 causes interactive identifier 804-5b to be disabled, any media assets corresponding to interactive identifier 804-5b may be disabled as well. For example, when interactive identifier 804-5b (which represents on-demand media) is disabled, media asset identifiers 502 that correspond to on-demand media assets may be disabled as well. The disabled media asset identifiers 502 may be disabled at user equipment 800b or at a second user equipment device 800c.

FIG. 8C shows an illustrative embodiment of a user equipment device that may display a plurality of selectable interactive identifiers reflecting categories, where one interactive identifier of the plurality of selectable identifiers has its interactivity disabled in response to user input received at a different user equipment device, in accordance with some embodiments of the disclosure. Control circuitry 304 may cause second user equipment device 800c to display On-Demand interactive identifier 806c. Control circuitry 304 may cause the interactivity of interactive identifier 806c to be disabled due to the activity depicted in FIG. 8A and FIG. 8B and described in the foregoing. Second user equipment device 800c is depicted as a television, such as user television equipment 402, but may be any other type of user equipment device such as user computer equipment 404 or wireless user communications device 406. Second user equipment 800c may share a local network with user equipment device 800a, or may be remote from user equipment 800a, and may receive instructions to disable interactive identifier 806c via communications network 414.

In some embodiments, when a user wishes to disable the interactivity of a particular interactive identifier, control circuitry 304 may receive a user input of a geometric shape that contains within its area some, but not all, of the particular interactive identifier. Control circuitry 304 may compare the amount of the particular interactive identifier that is within the area of the geometric shape with a threshold amount of a portion of an interactive identifier that must be within the area of the geometric shape, where the threshold amount indicates a portion of an interactive identifier that must be within the area of the geometric shape for the interactivity of the particular interactive identifier to be disabled.

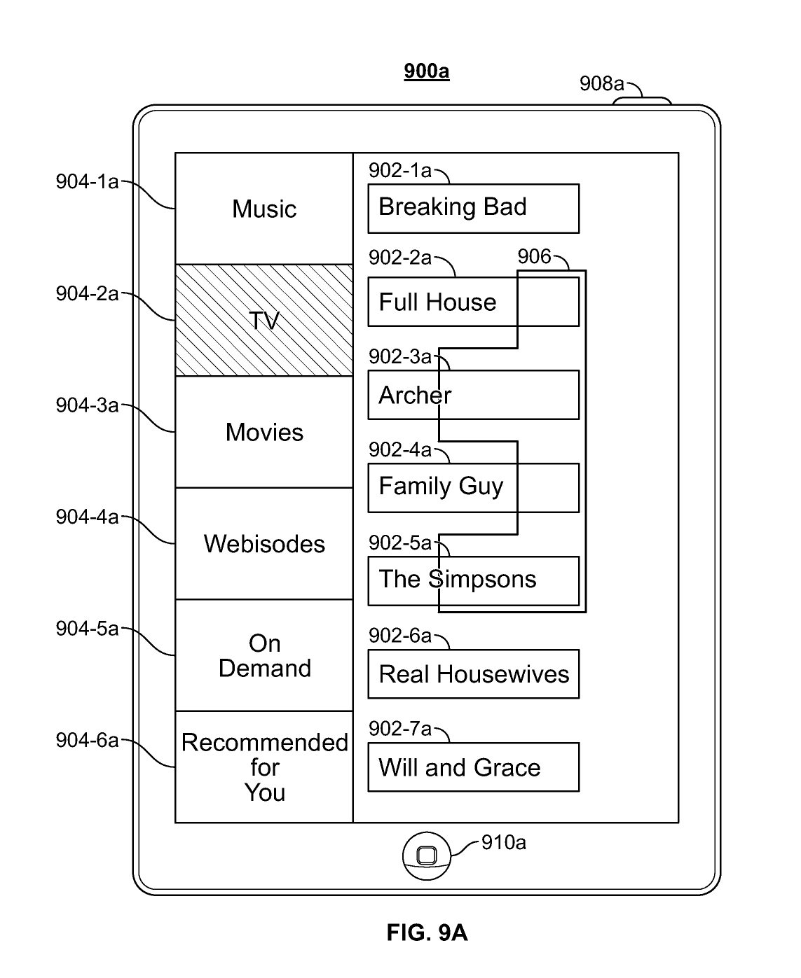

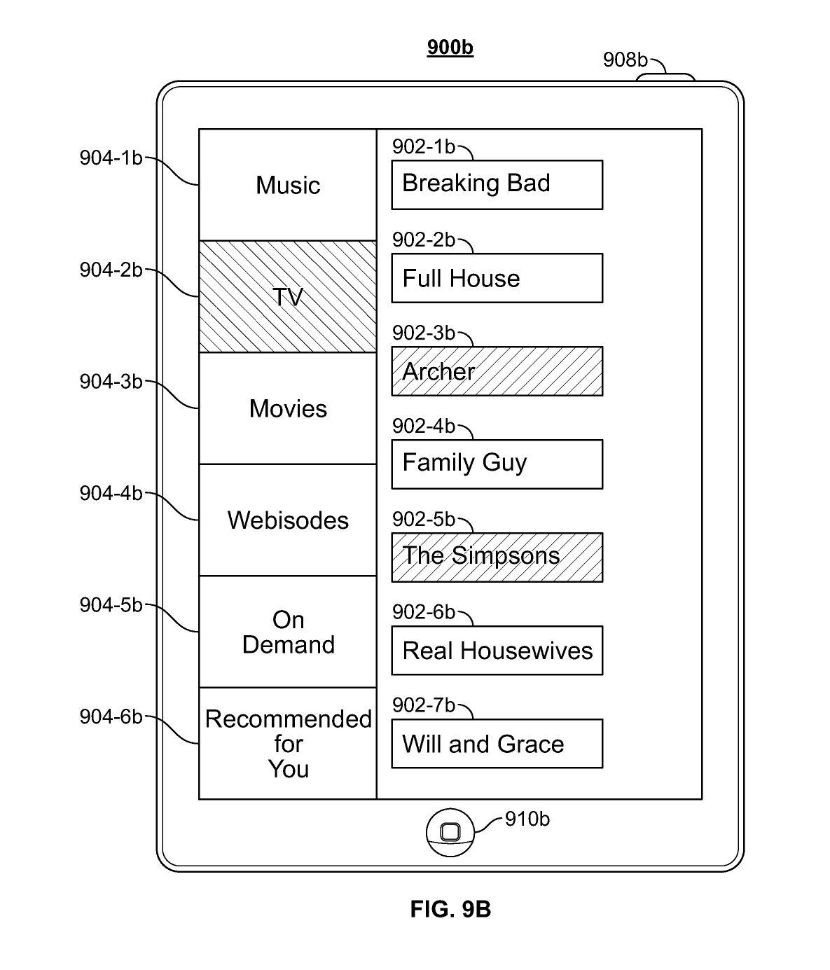

FIG. 9A shows an illustrative embodiment of a user equipment device that may display a plurality of selectable interactive identifiers and may receive user input of a geometric shape, in accordance with some embodiments of the disclosure. The geometric shape may be any user-input shape, such as asymmetrical geometric shape 906. Geometric shape 906 includes within its area, at least in part, portions of interactive identifiers 902-2a, 902-3a, 902-4a, 902-5a, and 902-6a. In some embodiments, as described in the foregoing, interactive identifiers with a threshold amount of the interactive identifier within the area of geometric shape 906a will have their interactivity disabled. In other embodiments, as described in the foregoing, even if a threshold amount of the interactive identifier is within the area of geometric shape 906a other conditions may dictate whether the interactivity of interactive identifier is disabled, such as a rating associated with the interactive identifier.

In order to determine an amount of a particular interactive identifier that is within the area of geometric shape 906a, control circuitry 304 may determine an area of the particular interactive identifier. Control circuitry 304 may also determine the area of the particular interactive identifier that is coextensive with the area of geometric shape 906a. In order to determine the area of the particular interactive identifier, control circuitry 304 may determine the coordinates of a particular interactive identifier's perimeter, and then calculate the area using any known means. For example, if the coordinates indicate that the particular interactive identifier is of a shape with a known area formula, control circuitry 304 may calculate the area using a known formula for that shape. Any means, conventional or unconventional, by which to calculate an exact or approximate area may be used. One example of an unconventional means to calculate the area of the perimeter of the particular interactive identifier is to calculate the number of pixels utilized to display the particular interactive identifier. Control circuitry 304 may calculate the area of the particular interactive identifier that is coextensive with the area of geometric shape 906a using the same means utilized to calculate the area of the particular interactive identifier.

In some embodiments, the threshold amount of the particular interactive identifier that must be within the area of geometric shape 906a for the interactivity of the particular interactive identifier may be a percentage. For example, the threshold may indicate that, when sixty-percent of the particular interactive identifier is within the area of geometric shape 906a, the interactivity of the particular interactive identifier should be disabled by control circuitry 304. Control circuitry 304 may determine whether the threshold is met by calculating the percentage of the particular interactive identifier that is within the area of geometric shape 906a. This percentage may be calculated by dividing the area of the particular interactive identifier that is coextensive with the area of geometric shape 906a by the area of the particular interactive identifier, and multiplying the quotient by one hundred.

In some embodiments, the threshold amount of the interactive identifier that must be within the area of geometric shape 906a will be automatically set or set in a factory. For example, control circuitry 304 may be programmed to operate based on factory settings that dictate that, if fifty-percent of an interactive identifier is within the area of geometric shape 906, then the interactivity of the interactive identifier is to be disabled. In some embodiments, a user may set the threshold amount, or may modify a factory-set or automatically-set amount of an interactive identifier that must be within the area of geometric shape 906a for control circuitry 304 to act to disable the interactivity of the interactive identifier.

FIG. 9B shows an illustrative embodiment of a user equipment device that may display a plurality of selectable interactive identifiers, where the interactivity of some interactive identifiers of the plurality of interactive identifiers is disabled if a threshold amount of an interactive identifier is within the area of the geometric shape, in accordance with some embodiments of the disclosure.

In FIG. 9B, interactive identifiers 902-3b and 902-5b may be visually distinguished to indicate that the interactivity of interactive identifiers 902-3b and 902-5b is disabled. Control circuitry 304 may have disabled the interactivity of interactive identifiers 902-3b and 902-5b in response to determining that geometric shape 906a held more than a threshold amount of fifty-percent of interactive identifiers 902-3b and 902-5b within its area. As described in the foregoing, in some embodiments control circuitry 304 may cause identifiers 902-3a and 902-5a to be disabled on a second user equipment device, such as user television equipment 402. The second user equipment device may be remote from user equipment device 900b and control circuitry 304 may communicate with the second user equipment device 900b via communications network 414.

In some embodiments, a user may wish to access content associated with an interactive identifier whose interactivity has been disabled. Control circuitry 304 may prompt the user to enter a password via display 312, where, if a correct password is entered by the user, control circuitry 304 may enable the user to access the content associated with the interactive identifier whose interactivity has been disabled. After entering a correct password, control circuitry 304 may also enable the user to modify the interactivity of certain interactive identifiers. Control circuitry 304 may also enable the interactivity of an interactive identifier which may not otherwise be available to a user. For example, factory settings may cause certain interactive identifiers, such as those associated with pornography, to have their interactivity disabled by default, whereby the interactivity of the interactive identifier may only be initially enabled responsive to entry of a password.

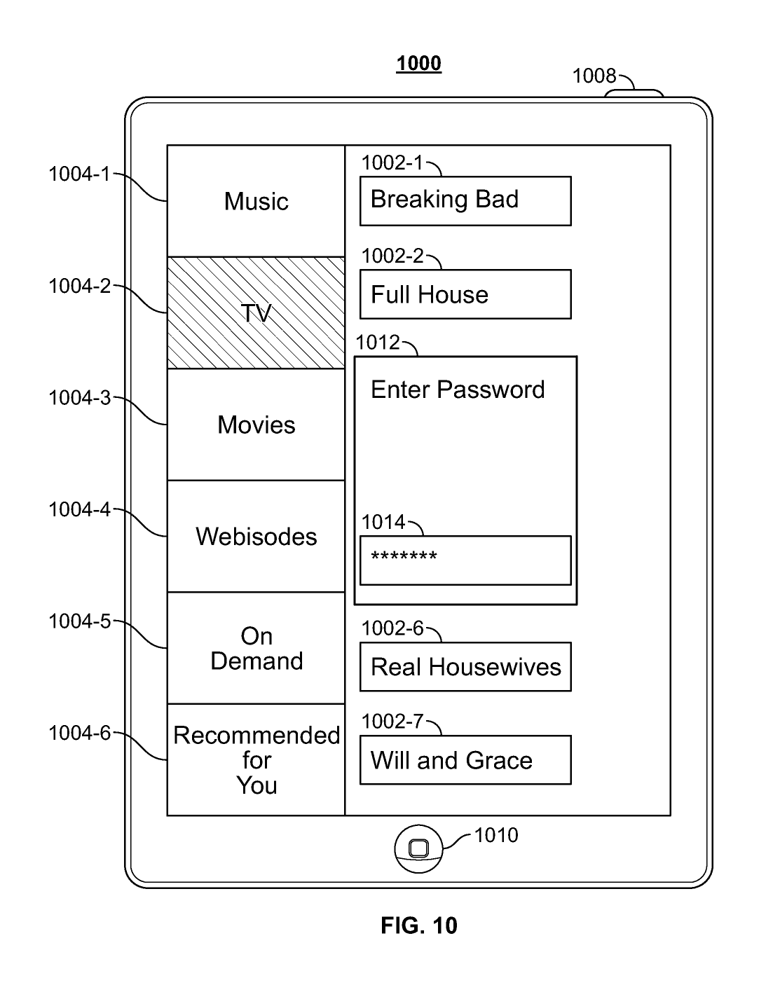

FIG. 10 shows an illustrative embodiment of a user equipment device that may display a prompt for a user to enter a password, in accordance with some embodiments of the disclosure. Prompt 1014 may be triggered by control circuitry 304 in response to detecting the depression of a physical button, such as button 1008 or 1010. Control circuitry 304 may also trigger prompt 1014 when a user acts to access prompt 1014 via a menu through user input interface 310, or when control circuitry 304 detects the entry of a certain gesture via user input interface 310. Control circuitry 304 may trigger prompt 1014 when a user attempts to interact with an interactive identifier whose interactivity has been disabled.

In some embodiments, when control circuitry 304 determines that password 1014 is correctly entered, control circuitry 304 enables a user to disable the interactivity of particular interactive identifiers. In some embodiments, when control circuitry 304 determines that password 1014 is correctly entered, control circuitry 304 may empower a user to enable the interactivity of interactive identifiers whose interactivity is presently disabled. Control circuitry 304 may check the entered password against a locally stored password in storage 308. Alternatively, control circuitry 304 may check the password against a remotely-stored password in a database, such as media content source 416 or media guidance data source 418, which would be accessed via communications network 414.

In some embodiments, some interactive identifiers may require enablement in order to gain interactivity. For example, when a user subscribes to a content provider, some content may be inaccessible unless an interactive identifier that corresponds to the content is enabled. In order to enable an interactive identifier corresponding to inaccessible content (e.g., interactive identifier 806C), control circuitry 304 may receive instructions that permit an interactivity of an interactive identifier to be enabled.

Instructions to enable an interactive identifier that has not gained interactivity may be input and processed in the same manner as the instructions described in the foregoing with regard to FIGS. 5-9. For example, a user may draw a geometric shape around an interactive identifier that is not enabled in order to enable the interactive identifier, where, when the non-enabled interactive identifier is within the area of the geometric shape (e.g., geometric shape 506), the interactivity of the non-enabled interactive identifier is enabled. These instructions may be received from a user via user input interface 310 (e.g., following the entry of a password as described with regard to FIG. 10 in the foregoing).

Alternatively, these instructions may be received by control circuitry 304 from a media content source (e.g., media content source 416) via communications network 414. A content provider (e.g., Comcast) may enable access to inaccessible content in response to a subscriber request. As an example, a user may order a sports package (e.g., NFL Sunday Ticket), and in response a content provider (e.g., Comcast) may transmit instructions to control circuitry 304 to enable the interactivity of an interactive identifier that provides access to the sports package, whereby control circuitry 304 may responsively perform the enablement.

Control circuitry 304 may determine whether an interactive identifier is enabled by accessing a database (e.g., media guidance data source 418) and querying the database as to whether the interactive identifier is enabled. When an interactive identifier is enabled, the interactive identifier may be disabled and/or re-enabled by control circuitry 304 in any manner described in this disclosure.

In some embodiments, a user may view interactive identifiers on a scrollable page and may wish to restrict access to certain interactive identifiers. For example, a user may wish to restrict access to pay-per-view media content, and may therefore wish to disable the interactivity of interactive identifiers associated with pay-per-view media content. Control circuitry 304 may detect user input of a geometric shape that contains the interactive identifiers associated with the media content the user wishes to restrict, such as the pay-per-view-media content, within its area. Control circuitry 304 may determine that a particular interactive identifier is within the area of the geometric shape, and may disable the interactivity of that particular interactive identifier. Control circuitry 304 may detect user input that may cause the scrollable page to be scrolled, and may act to maintain the disabled interactivity of the particular interactive identifier despite the movement of the particular interactive identifier's position on the display as the page is scrolled.

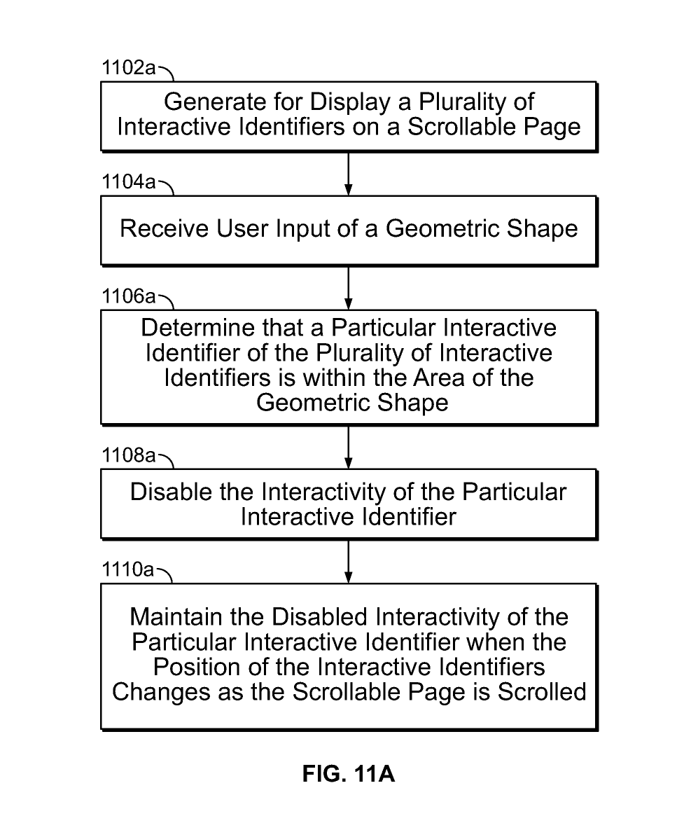

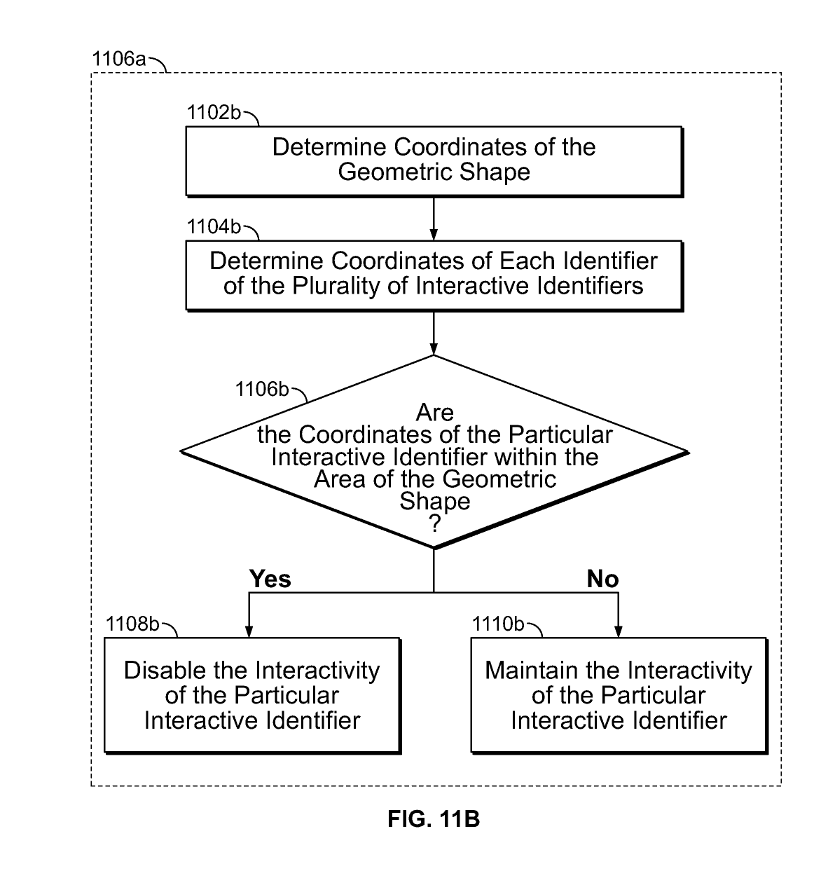

FIG. 11A is a flowchart of illustrative steps involved in disabling the interactivity of interactive identifiers on a scrollable page that are within the area of a user input geometric shape, in accordance with some embodiments of the disclosure.

In step 1102a, control circuitry 304a may generate a display of a plurality of interactive identifiers on a scrollable page. The scrollable page may be a page on computer equipment 404, such as a laptop or a tablet, or may be on a wireless user communications device 406, such as a mobile telephone, or may be on user television equipment 402. The interactive identifiers may be media asset identifiers 502 or media content identifiers 504.

In step 1104a, control circuitry 304 may detect user input of a geometric shape, such as geometric shape 506. The control circuitry 304 may detect the user input as made via user input interface 310 in any manner including by way of a peripheral device such as a mouse or trackball, or by interaction between user input interface 310 and a stylus or one's finger. Control circuitry 304 may determine that the geometric shape is a closed shape. Should control circuitry 304 not determine that the geometric shape is a closed shape, control circuitry 304 may determine that the geometric shape approximates a geometric shape, and may complete the drawing of the closed shape.

In step 1106a, control circuitry 304 may determine that a particular interactive identifier of the plurality of interactive identifiers is within the area of the geometric shape. In making this determination, control circuitry 304 may consider whether a threshold amount of the particular interactive identifier is within the area of the geometric shape, as discussed in the foregoing.

In step 1108a, control circuitry 304 may disable the interactivity of the particular interactive identifier in response to the determination of step 1106a. Control circuitry 304 may visually distinguish the display of the particular interactive identifier on display 312 as described in the foregoing. Control circuitry 304 may display the disabled particular interactive identifier on the same device that the geometric shape was input, or on a different device, as discussed in the foregoing.

In step 1110a, control circuitry 304 may maintain the disabled interactivity of the particular interactive identifier when the position of the particular interactive identifier changes on display 312 as control circuitry 304 causes the page to be scrolled in response to user input. Control circuitry 304 may cause the page to be scrolled in response to user input received at user input interface 310, such as a finger moved up on the interactive display 312 of a tablet computer 404. As the page is scrolled, control circuitry acts to maintain the disabled interactivity of the particular interactive identifier despite a change of the particular interactive identifier's position on display 312.

In some embodiments, control circuitry 304 may act to determine whether the particular interactive identifier described with regard to FIG. 11A is within the area of the geometric shape. In order to perform this determination, control circuitry 304 may determine the coordinates of the geometric shape and the coordinates of the particular interactive identifier. If control circuitry 304 determines that the coordinates of the particular interactive identifier are within the area of the geometric shape, control circuitry 304 may disable the interactivity of the particular interactive identifier.

FIG. 11B is a flowchart of illustrative steps involved in determining whether a particular interactive identifier on a scrollable page is within the area of the geometric shape based on the coordinates of the geometric shape and the coordinates of the particular interactive identifier, in accordance with some embodiments of the disclosure.

In step 1102b, control circuitry 304 may determine the coordinates of the user input geometric shape. If a touch-screen device is used, control circuitry 304 may base the determination on the location of a user input interface 310 that a user interacts with.

In step 1104b, control circuitry 304 may determine the coordinates of the interactive identifiers. Control circuitry 304 may make this determination by determining the contact points of the user input on user input interface 310, as described in the foregoing.

In step 1106b, control circuitry 304 may determine whether the coordinates of the particular interactive identifier are within the area of the geometric shape. Circuitry may perform this determination by comparing the coordinates learned in steps 1104b to the coordinates learned in step 1102b. If the coordinates of the particular interactive identifier are within the area of the geometric shape, control circuitry 304 may trigger step 1108b. If the coordinates of the particular interactive identifier are not within the area of the geometric shape, control circuitry 304 may trigger step 1110b. As discussed in the foregoing, an amount of the particular interactive identifier that is within the area of the geometric shape may be calculated (e.g., by control circuitry 304) and compared to a threshold to determine whether the interactivity of the particular interactive identifier is to be disabled.

In step 1108b, control circuitry 304 may determine that the coordinates of the particular interactive identifier are within the area of the geometric shape (e.g., by control circuitry 304), and may responsively disable the interactivity of the particular interactive identifier.

In step 1110b, control circuitry 304 may determine that the coordinates of the particular interactive identifier are not within the area of the geometric shape, and may responsively maintain the interactivity of the particular interactive identifier.

In some embodiments, a user may wish to disable the interactivity of a particular interactive identifier at a user equipment device that the user is remote from. The user may wish to use a user equipment device that the user is local to in order to perform the remote disabling.

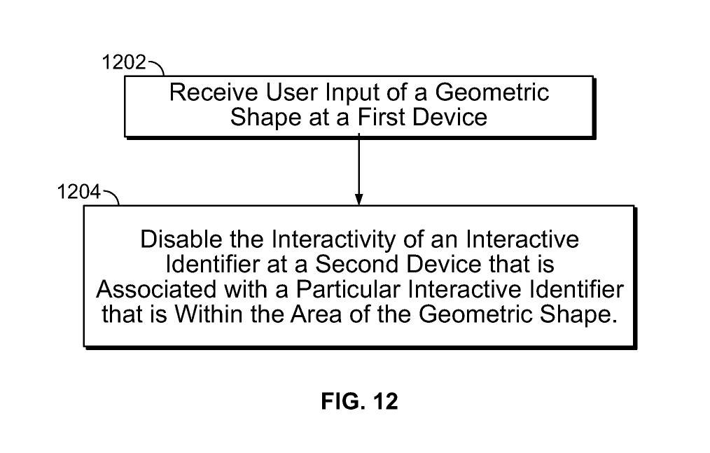

FIG. 12 is a flowchart of illustrative steps taken to disable the interactivity of a particular interactive identifier at a second user equipment device based on the received user input of a geometric shape at a first user equipment device, in accordance with some embodiments of the disclosure.

In step 1202, control circuitry 304 may receive user input of a geometric shape at a first user equipment device. The user input may be input via user input interface 310 and may be input in any manner described in the foregoing, such as via a mouse or trackball, a human body part, or a stylus.

In step 1204, in response to the user input of the geometric shape at the first user equipment device, control circuitry 304 may disable the interactivity of an interactive identifier covered by the area of the geometric shape at a second user equipment device. The second user equipment device may be on a local network relative to the first user equipment device, such as communications network 414. The second user equipment device may be on a remote network relative to the first user equipment device, and may learn to disable the interactivity of the interactive identifier by a communication from control circuitry 304 via communications network 414.

In some embodiments, a user may wish to input a geometric shape that does includes some, but not all, of a particular interactive identifier. A threshold amount may be set such that, if a threshold amount of an interactive identifier is within the area of the geometric shape, then control circuitry 304 may disable the interactivity of the interactive identifier.

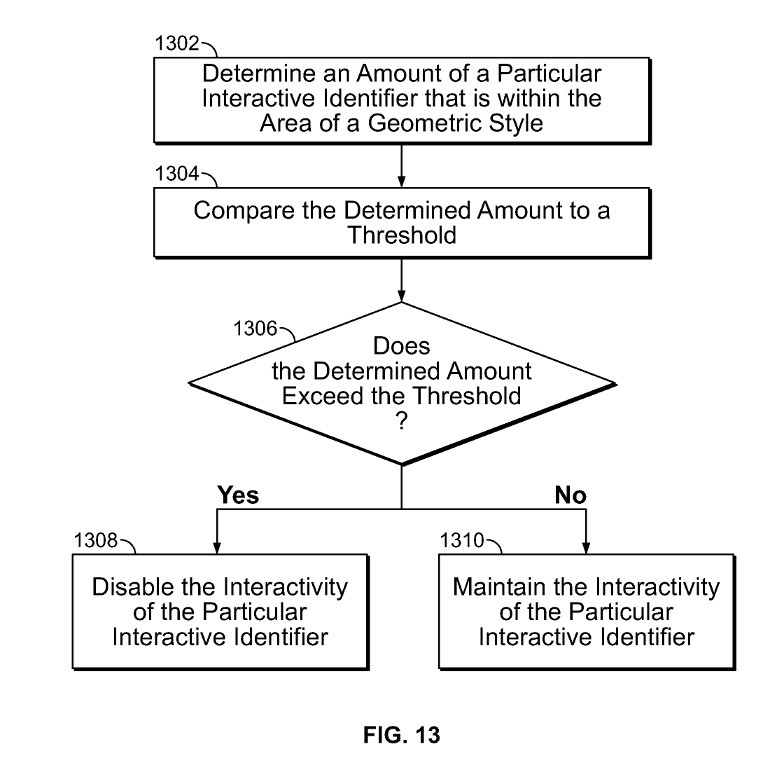

FIG. 13 is a flowchart of illustrative steps involved in a determination of whether to disable a particular interactive identifier that is within the area of a user input geometric shape, in accordance with some embodiments of the disclosure.

In step 1302, control circuitry 304 may determine the amount of the particular interactive identifier that is within the area of the geometric shape. This amount may be determined based on coordinates of the particular interactive identifier as well as the coordinates of the area of the interactive identifier that is coextensive with the area of the geometric shape, as described in the foregoing, or through any other means.

In step 1304, control circuitry 304 may compare the amount determined in step 1302 to a threshold amount (e.g., by control circuitry 304). The threshold amount may be defined by a user, by factory settings, or automatically by control circuitry 304.

In step 1306, control circuitry 304 may determine whether the amount determined in step 1302 exceeds the threshold based on the comparison of step 1304. This determination may be made via control circuitry 304.

If control circuitry 304 determines that the amount of the particular interactive identifier within the area of the geometric shape exceeds the threshold, then step 1308 may be triggered, whereby control circuitry 304 may disable the interactivity of the particular interactive identifier. If control circuitry 304 determines that the amount of the particular interactive identifier within the area of the geometric shape does not exceed the threshold, then control circuitry 304 may act to trigger step 1310, and may maintain the interactivity of the particular interactive identifier.

In some embodiments, a user may wish to interact with an interactive identifier whose interactivity has been disabled. In order to interact with the disabled interactive identifier, control circuitry 304 may prevent the user from interacting with the disabled interactive identifier unless the user enters a correct password in response to a prompt triggered by control circuitry 304. Should control circuitry 304 determine that the user input a correct password in response to the prompt, control circuitry 304 may enable the interactivity of disabled interactive identifiers.

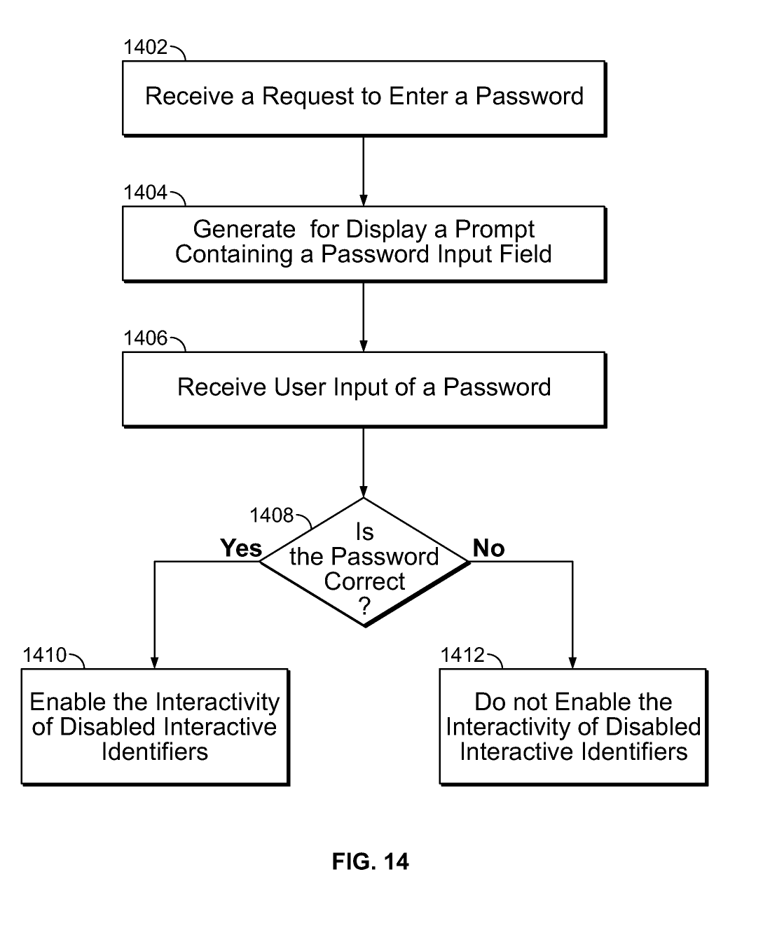

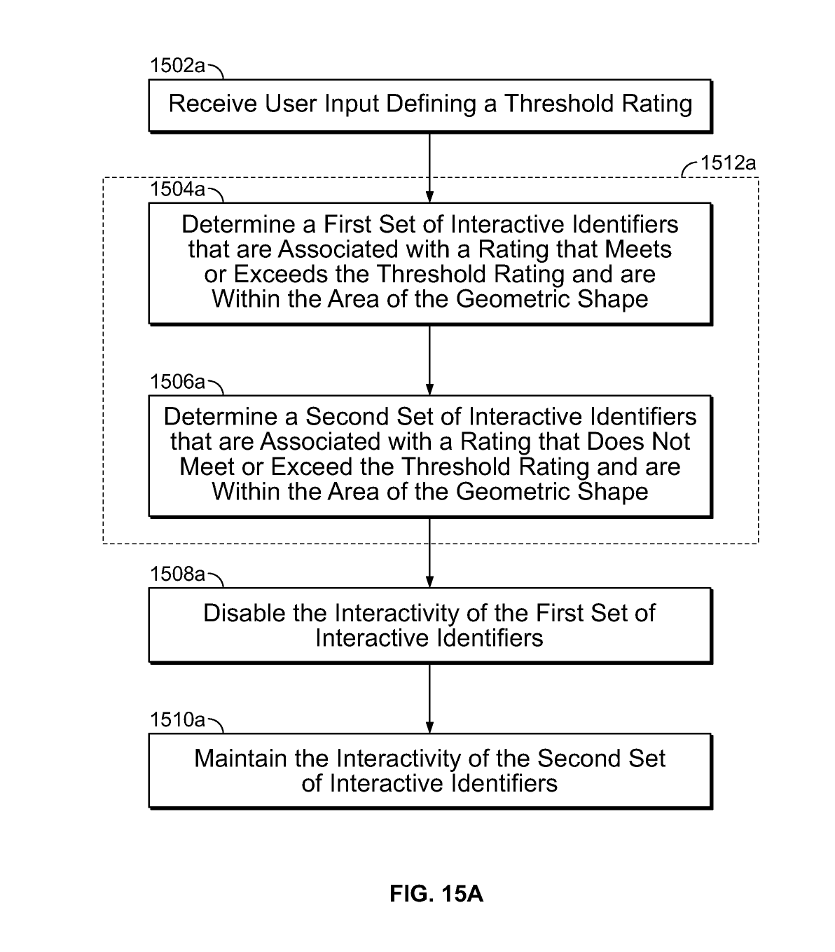

FIG. 14 is a flowchart of illustrative steps involved in enabling the interactivity of disabled interactive identifiers in response to the correct entry of a password by a user, in accordance with some embodiments of the disclosure. In step 1402, control circuitry 304 may receive a request to enter a password. In some embodiments, the request may be an attempt by a user to interact with an interactive identifier whose interactivity is disabled. In some embodiments, the request may be received by control circuitry 304 in response to user input in a menu display on display 312.

In step 1404, in response to receipt of the request, control circuitry 304 may generate a prompt for display containing a password input field. The prompt may be displayed on display 312, and may be generated for display at a user equipment device via control circuitry 304, or may be generated for display at a remote server and communicated to the user equipment device via communications network 414.

In step 1406, control circuitry 304 may receive user input of the password. The password may be input via user input interface 310. In step 1408, the password may be verified by control circuitry 304. In some embodiments, the verification may be performed by comparing the password to a key that is stored at a database, such as media guidance 418.

Should control circuitry 304 determine that the password entered is a correct password, in step 1410 control circuitry 304 may enable an interactive identifier whose interactivity has been disabled. Should control circuitry 304 determine that the password is not a correct password, in step 1412 control circuitry 304 may refrain from disabling the interactivity of an interactive identifier whose interactivity has not been disabled. In some embodiments, rather than control circuitry 304 enabling all interactive identifiers when a correct password is input, step 1410 may be replaced with a step that allows a user to manage the interactivity of interactive identifiers. For example, control circuitry 304 may empower the user to selectively enable or disable the interactivity of one or more interactive identifiers.

In some embodiments, a user may wish to set a threshold rating, such that interactive identifiers that are within the area of a user input geometric shape are only disabled by control circuitry 304 if control circuitry 304 determines that the interactive identifiers exceed the threshold rating. For example, a user may wish to restrict access to rated-R movies, and, therefore when a plurality of interactive identifiers associated with movies is within the area of the geometric shape, control circuitry 304 may disable the interactivity of any interactive identifier of the plurality of interactive identifiers with a rating of R.

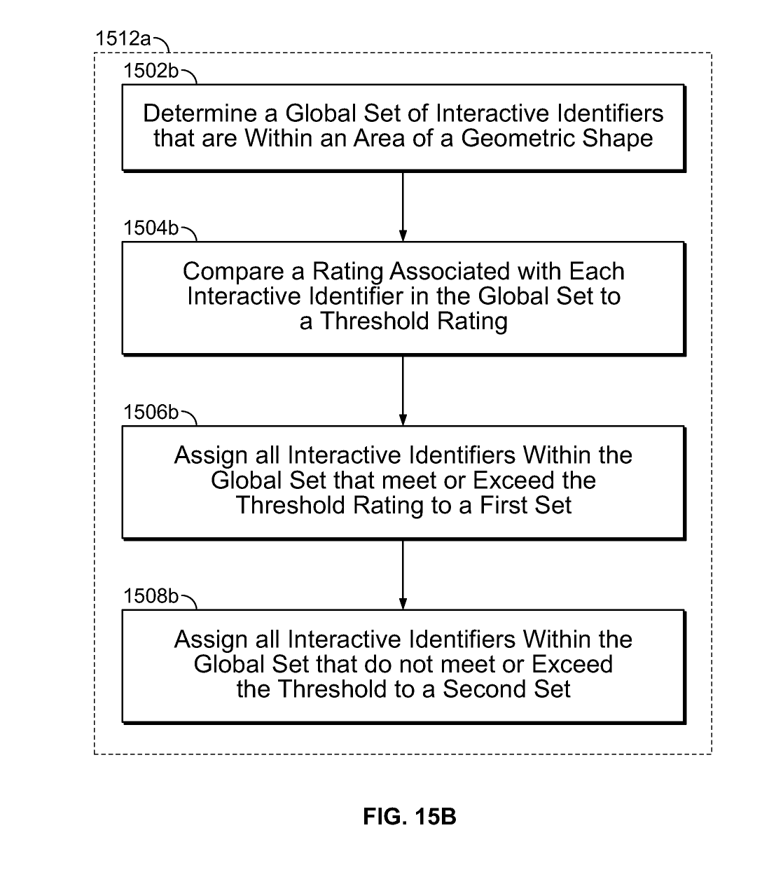

FIG. 15A is a flowchart of illustrative steps taken to selectively disable the interactivity of a first set of interactive identifiers within the area of a user input geometric shape and maintain the interactivity of a second set of interactive identifiers within the area of the user input geometric shape, in accordance with some embodiments of the disclosure. In step 1502a, control circuitry 304 may receive a user input that defines a threshold rating. User input may be received, for example, via user input interface 310. The threshold rating may be a rating selected from a plurality of ratings. Potential ratings systems that may be used consistent with this disclosure include MPAA movie ratings (i.e., “G,” “PG,” “PG-13,” etc.), The TV Parental Guidelines (i.e., “TV-MA,” “TV-G,” etc.) and other ratings that correspond to a level of profanity or violence in a media asset. Alternatively, or additionally, ratings may indicate a popularity level or the opinion of a critic.

In step 1504a, control circuitry 304 may determine a first set of interactive identifiers that are associated with a rating that meets or exceeds the threshold rating and are within the area of the geometric shape. Control circuitry 304 may perform this determination by accessing storage 308 to compare a rating stored therein and associated with an individual interactive identifier against the threshold rating.

In step 1506a, a second set of interactive identifiers that are associated with a rating that meets or exceeds the threshold rating and are within the area of the geometric shape may be determined by control circuitry 304. Control circuitry 304 may perform this determination by accessing storage 308 to compare a rating stored therein and associated with an individual interactive identifier with the threshold rating.

In step 1508a, control circuitry 304 may disable the interactivity of the first set of interactive identifiers, where, in step 1510a, the interactivity of the second set of interactive identifiers may be maintained by control circuitry 304. Step 1510a is provided for illustrative purposes only, and may be modified in any manner consistent with this disclosure. For example, step 1504a may only include elements in the first set which actually exceed a threshold rating, rather than meet or exceed the threshold rating. As another example, step 1504a may form the second set, and step 1506a may form the first set, such that step 1508a acts to disable the interactivity of interactive identifiers associated with a rating that is beneath a threshold rating.

FIG. 15B is a flowchart of illustrative steps taken to distinguish interactive identifiers of a global set of interactive identifiers within the area of a geometric shape that meet or exceed a threshold rating from those that do not meet or exceed the threshold rating, in accordance with some embodiments of the disclosure. In some embodiments, FIG. 15B may act to cause the steps of item 1512a to occur.

In step 1502b, control circuitry 304 may determine a global set of interactive identifiers within the area of a user input geometric shape. The global set may include some or all interactive identifiers within the area of the geometric shape.

In step 1504b, a rating associated with each interactive identifier of the global set of interactive identifiers may be compared to a threshold rating by control circuitry 304. Control circuitry 304 may retrieve the threshold rating from local storage 308 or via communications network 414 from a storage associated with a remote content source, such as media content source 416.

In step 1506b, all interactive identifiers that are within the global set that meet or exceed the threshold rating may be assigned to the first set by control circuitry 304. Similarly, in step 1508b, all interactive identifiers that are within the global set that do not meet or exceed the threshold rating may be assigned to the second set by control circuitry 304. Once steps 1506b and 1508b are performed, control circuitry 304 may disable the interactivity or maintain the interactivity consistent with steps 1508a and 1510a.

In some embodiments, a profile of a user may be used by control circuitry 304 to determine which interactive identifiers of a set of interactive identifiers that is within the area of a user input geometric shape may be disabled. For example, if an adult is watching television, the adult's profile may reflect that children's shows and dramas are types of media assets that the adult would be unlikely to watch. Accordingly, the interactivity of interactive identifiers associated with media assets that the adult would be unlikely to watch that are within the area of the geometric shape may be disabled by control circuitry 304.

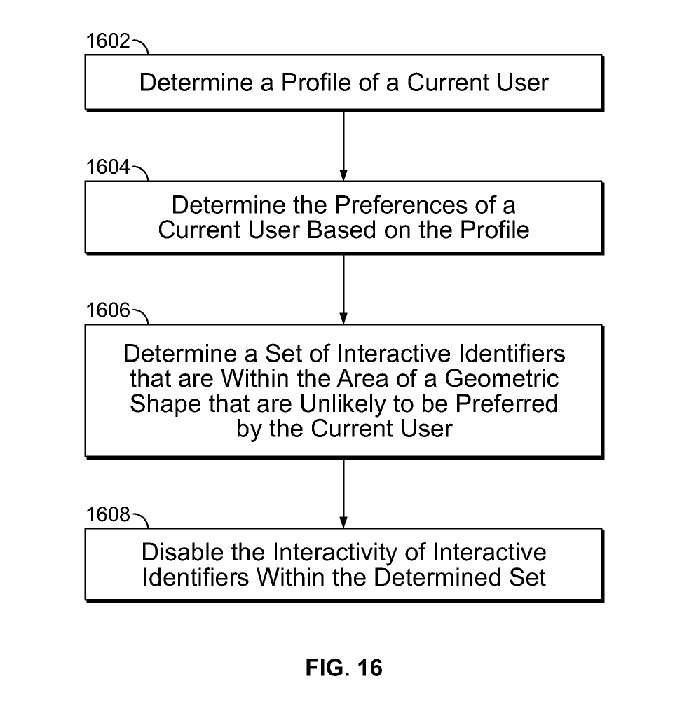

FIG. 16 is a flowchart of illustrative steps taken to selectively disable the interactivity of a set of interactive identifiers within the area of a user input geometric shape that are unlikely to be preferred by a user who input the geometric shape, in accordance with some embodiments of the disclosure. In step 1602a, the profile of a current user may be determined (e.g., by way of control circuitry 304). The profile of the current user may be determined by the current user logging in, by using vision recognition technology, or by any other means that ascertains the identity or the probable identity of the current user.

In step 1604, the preferences of the current user are determined by control circuitry 304 based on the user profile. The profile may be stored locally at storage 308, or remotely on a database, such as media content source 416. If stored remotely, the database may be accessed via communications network 414 by control circuitry 304.

In step 1606, a set of interactive identifiers that are within the area of the geometric shape that are associated with media assets that are unlikely to be preferred by the user may be determined by control circuitry 304. Media assets that are unlikely to be preferred by the user may be explicitly defined by a user, or may be inferred by control circuitry 304 based on past activity of the user.

In step 1608, the interactive identifiers of the set of interactive identifiers determined in step 1606 may have their interactivity disabled by control circuitry 304.

It will be apparent to those of ordinary skill in the art that methods involved in the present invention may be embodied in a computer program product that includes a computer usable and/or readable medium. For example, such a computer usable medium may consist of a read-only memory device, such as a CD-ROM disk or conventional ROM devices, or a random access memory, such as a hard drive device or a computer diskette, having a computer readable program code stored thereon. It should also be understood, that methods, techniques, and processes involved in the present invention may be executed using processing circuitry. For instance, determination of a set of interactive identifiers that are within the area of a geometric shape as described herein may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 108 or one of servers 122 of FIG. 1. For example, the user profile information as described herein may be stored in, and retrieved from, storage 308 of FIG. 3, or media guidance data source 418 of FIG. 4. Furthermore, processing circuitry, or a computer program, may update settings associated with a user, such as a threshold rating, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes.

1. A method comprising:
generating for display a plurality of interactive identifiers on a scrollable page;
receiving a user input of a geometric shape on the scrollable page;
determining that a particular interactive identifier of the plurality of interactive identifiers is within the area of the geometric shape; and
disabling interactivity of the particular interactive identifier in response to the determining, wherein the interactivity of the particular interactive identifier remains disabled when a position on a display of the particular interactive identifier changes as the scrollable page is scrolled.

2. The method of claim 1, wherein another interactive identifier is within the area of the geometric shape, and wherein the another interactive identifier's interactivity is not disabled.

3. The method of claim 1, further comprising:
receiving a selection of an interactive identifier of the plurality of interactive identifiers on a first user equipment device; and
generating for display a media asset corresponding to the interactive identifier on a second user equipment device.

4. The method of claim 1, wherein the user input is performed at a first device, and wherein media associated with the particular interactive identifier is restricted at a second device in response to the determining.

5. The method of claim 4, wherein the plurality of interactive identifiers are generated for display at the second device, and wherein disabled interactive identifiers are visually distinguished from non-disabled interactive identifiers.

6. The method of claim 1, further comprising:
determining a profile of a current user;
determining the preferences of the current user based on the profile;
determining a set of interactive identifiers of the plurality of interactive identifiers that are (1) within the area of the geometric shape and (2) unlikely to be preferred by the current user;
disabling the interactivity of the set of interactive identifiers; and
maintaining the interactivity of all other interactive identifiers within the area of the geometric shape.

7. The method of claim 1, wherein the determining further comprises:
determining an amount of the particular interactive identifier that is within the area of the geometric shape;
comparing the amount to a threshold;
determining whether the amount exceeds a threshold; and
in response to determining that the amount exceeds the threshold, disabling the particular interactive identifier.

8. The method of claim 1, further comprising:
receiving a request to enter a password;
generating for display a prompt comprising a password input field; and
enabling a selection of all disabled interactive identifiers in response to receiving a correct password.

9. The method of claim 1, further comprising:
receiving user input that defines a threshold rating;
determining a first set of interactive identifiers of the plurality of identifiers that are associated with a rating that meets or exceeds the threshold rating and are within the area of the geometric shape;
determining a second set of interactive identifiers of the plurality of identifiers that are associated with a rating that does not meet or exceed the threshold rating and are within the area of the geometric shape;
disabling interactivity of the first set of interactive identifiers; and
maintaining interactivity of the second set of interactive identifiers.

10. The method of claim 9, wherein the threshold rating is selected from a plurality of ratings, and wherein each rating of the plurality of ratings corresponds to a level of profanity associated with a media asset.

11. A system comprising a processor configured to:
generate for display a plurality of interactive identifiers on a scrollable page;
receive a user input of a geometric shape on the scrollable page;
determine that a particular interactive identifier of the plurality of interactive identifiers is within the area of the geometric shape; and
disable interactivity of the particular interactive identifier in response to the determining, wherein the interactivity of the particular interactive identifier remains disabled when a position on a display of the particular interactive identifier changes as the scrollable page is scrolled.

12. The system of claim 11, wherein another interactive identifier is within the area of the geometric shape, and wherein the another interactive identifier's interactivity is not disabled.

13. The system of claim 11, wherein the processor is further configured to:
receive a selection of an interactive identifier of the plurality of interactive identifiers on a first user equipment device; and
generate for display a media asset corresponding to the interactive identifier on a second user equipment device.

14. The system of claim 11, wherein the user input is performed at a first device, and wherein media associated with the particular interactive identifier is restricted at a second device in response to the determining.

15. The system of claim 14, wherein the plurality of interactive identifiers are generated for display at the second device, and wherein disabled interactive identifiers are visually distinguished from non-disabled interactive identifiers.

16. The system of claim 11, wherein the processor is further configured to:
determine a profile of a current user;
determine the preferences of the current user based on the profile;
determine a set of interactive identifiers of the plurality of interactive identifiers that are (1) within the area of the geometric shape and (2) unlikely to be preferred by the current user;
disable the interactivity of the set of interactive identifiers; and
maintain the interactivity of all other interactive identifiers within the area of the geometric shape.

17. The system of claim 11, wherein during the determination, the processor is further configured to:
determine an amount of the particular interactive identifier that is within the area of the geometric shape;
compare the amount to a threshold;
determine whether the amount exceeds a threshold; and
in response to determining that the amount exceeds the threshold, disable the particular interactive identifier.

18. The system of claim 11, wherein the processor is further configured to:
receive a request to enter a password;
generate for display a prompt comprising a password input field; and
enable a selection of all disabled interactive identifiers in response to receiving a correct password.

19. The system of claim 11, wherein the processor is further configured to:
receive user input that defines a threshold rating;
determine a first set of interactive identifiers of the plurality of identifiers that are associated with a rating that meets or exceeds the threshold rating and are within the area of the geometric shape;
determine a second set of interactive identifiers of the plurality of identifiers that are associated with a rating that does not meet or exceed the threshold rating and are within the area of the geometric shape;
disable interactivity of the first set of interactive identifiers; and
maintain interactivity of the second set of interactive identifiers.

20. The system of claim 19, wherein the threshold rating is selected from a plurality of ratings, and wherein each rating of the plurality of ratings corresponds to a level of profanity associated with a media asset.

21-50. (canceled)
